(19) United States
(12) Patent Application Publication
(10) Pub. No.: US 2026/0245456 A1
(43) Pub. Date: Aug. 20, 2026

(54) METHODS AND SYSTEMS FOR PERFORMING EMERGENCY MONITORING OF TRAFFIC ANOMALIES IN SMART CITIES BASED ON INTERNET OF THINGS LARGE-SCALE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guanghua HUANG, Chengdu (CN); Hongjian LIU, Chengdu (CN)

(73) Assignee: CHENGDU QINCHUAN IOT TECHNOLOGY CO., LTD., Chengdu (CN)

(21) Appl. No.: 19/641,474

(22) Filed: Apr. 7, 2026

(30) Foreign Application Priority Data
Feb. 25, 2026 (CN) 202610224834.3

(51) Int. Cl. G08G 1/0968; G06V 10/82; G06V 20/54; G08G 1/01; G08G 1/07; G08G 1/16

(52) U.S. Cl. CPC G08G 1/096811; G06V 10/82; G06V 20/54; G08G 1/0108; G08G 1/0133; G08G 1/0141; G08G 1/0145; G08G 1/07; G08G 1/164; G08G 1/166; G08G 1/167

(57) ABSTRACT

Disclosed herein are a system and method for performing emergency monitoring of traffic anomalies in a smart city based on an Internet of Things (IoT) large-scale model. The system includes an emergency supervision management platform and an emergency supervision object platform, and the emergency supervision management platform includes an anomaly discrimination module and a diversion module. The anomaly discrimination module is configured to obtain multi-source data of a plurality of road sections in a target region; perform anomaly determination on the target region according to the multi-source data, and determine a plurality of hazard hot zones. The diversion module is configured to: for each of the plurality of hazard hot zones, determine a plurality of alternative routes according to a determination result of the anomaly determination and a regional road network topology map; determine primary recommended routes corresponding to a plurality of variable message signs according to the plurality of alternative routes and position information of the plurality of variable message signs, and generate a diversion instruction to send to the emergency supervision object platform; and control each of the plurality of variable message signs to display a schematic diagram of a corresponding primary recommended route, and control traffic signal lights on the plurality of alternative routes to display green light signals according to the traffic cycle, based on the diversion instruction.

### CROSS-REFERENCE TO RELATED APPLICATIONS

This application claims priority to Chinese Patent Application No. 202610224834.3, filed on Feb. 25, 2026, the entire contents of which are incorporated herein by reference.

### TECHNICAL FIELD

The present disclosure relates to the field of Internet of Things (IoT) and smart city traffic management, and particularly relates to a method and a system for performing emergency monitoring of traffic anomalies in a smart city based on an IoT large-scale model.

### BACKGROUND

With the continuous growth of the urban population and vehicle ownership, the traffic flow carried by road networks is steadily increasing. Traffic management departments deploy multi-type sensing devices to collect multi-source data in real time, providing support for traffic situation characterization and abnormal behavior recognition. However, complex scenes and road network structures lead to high uncertainty in abnormal events, which may trigger chain congestion. How to shorten response time, improve recognition accuracy, and enhance regulation flexibility in the background of data expansion has become a key challenge for smart traffic management.

Therefore, it is necessary to provide a method for performing emergency monitoring of traffic anomalies in a smart city based on an Internet of Things (IoT) large-scale model to fully release the potential of the multi-source data to meet the needs of city managers for timely identification and dynamic regulation of abnormal driving behaviors.

### SUMMARY

One or more embodiments of the present disclosure provide a system for performing emergency monitoring of traffic anomalies in a smart city based on an Internet of Things (IoT) large-scale model. The system includes an emergency supervision management platform and an emergency supervision object platform. The emergency supervision management platform includes an anomaly discrimination module and a diversion module. The anomaly discrimination module and the diversion module are configured to execute a method for performing emergency monitoring of traffic anomalies in a smart city based on the IoT large-scale model.

One or more embodiments of the present disclosure provide a method for performing emergency monitoring of traffic anomalies in a smart city based on an Internet of Things (IoT) large-scale model. The method is executed by an emergency supervision management platform of a system for performing emergency monitoring of traffic anomalies in a smart city based on the IoT large-scale model, and the method includes: obtaining multi-source data of a plurality of road sections in a target region, the multi-source data including road image data, terminal report data, and sensor data; performing anomaly determination on the target region according to the multi-source data, and determining a plurality of hazard hot zones, at least one abnormal driving behavior, including sudden braking, sudden turning, or lane departure, existing in the plurality of hazard hot zones; for each of the plurality of hazard hot zones, determining a plurality of alternative routes according to a determination result of the anomaly determination and a regional road network topology map, determining primary recommended routes corresponding to a plurality of variable message signs according to the plurality of alternative routes and position information of the plurality of variable message signs, and generating a diversion instruction to send to an emergency supervision object platform, the diversion instruction including schematic diagrams of the plurality of alternative routes and a traffic cycle, and controlling each of the plurality of variable message signs to display the schematic diagram of a corresponding primary recommended route, and controlling traffic signal lights on the plurality of alternative routes to display green light signals according to the traffic cycle, based on the diversion instruction.

One or more embodiments of the present disclosure provide an apparatus for performing emergency monitoring of traffic anomalies in a smart city based on an Internet of Things (IoT) large-scale model, including a processor. The processor is configured to execute the method for performing emergency monitoring of traffic anomalies in a smart city based on the IoT large-scale model.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a platform structure of a system for performing emergency monitoring of traffic anomalies in a smart city based on an Internet of Things (IoT) large-scale model according to some embodiments of the present disclosure;

FIG. 2 is an exemplary flowchart illustrating a method for performing emergency monitoring of traffic anomalies in a smart city based on an Internet of Things (IoT) large-scale model according to some embodiments of the present disclosure;

FIG. 3 is a schematic diagram illustrating an exemplary process for determining a plurality of hazard hot zones according to some embodiments of the present disclosure; and

FIG. 4 is a schematic diagram illustrating an exemplary process for determining a plurality of alternative routes according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they can achieve the same purpose.

As used in the present disclosure and the appended claims, unless the context clearly indicates otherwise, the terms “a,” “an,” “one,” and/or “the” are not intended to refer exclusively to the singular, but may also include the plural. In general, the terms “comprise” and “include” merely indicate the inclusion of explicitly identified steps and elements, which do not constitute an exhaustive list. Methods or devices may also contain other steps or elements.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts, and one or more operations may be removed from the flowcharts.

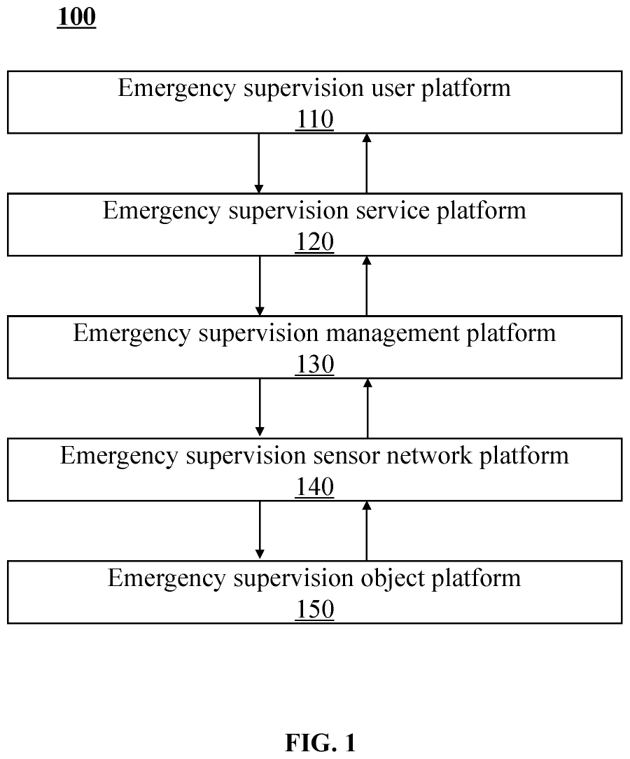

FIG. 1 is a schematic diagram illustrating a platform structure of a system for performing emergency monitoring of traffic anomalies in a smart city based on an Internet of Things (IoT) large-scale model according to some embodiments of the present disclosure.

In some embodiments, as shown in FIG. 1, the system 100 for performing emergency monitoring of traffic anomalies in a smart city based on the IoT large-scale model includes an emergency supervision user platform 110, an emergency supervision service platform 120, an emergency supervision management platform 130, an emergency supervision sensor network platform 140, and an emergency supervision object platform 150.

The emergency supervision user platform 110 refers to a platform configured to interact with a user.

In some embodiments, the emergency supervision user platform 110 may be configured as a terminal or a server for use by the user.

The emergency supervision service platform 120 refers to a platform configured to convey user requirements and control information.

In some embodiments, the emergency supervision service platform 120 may be configured as a terminal or a server for communication.

In some embodiments, the emergency supervision service platform 120 may interact with the emergency supervision user platform 110 and the emergency supervision management platform 130.

The emergency supervision management platform 130 refers to a platform for generating supervision information and executing control information.

In some embodiments, the emergency supervision management platform 130 may be configured as a processor or a server that implements emergency management functions.

In some embodiments, the emergency supervision management platform 130 includes an anomaly discrimination module and a diversion module.

The anomaly discrimination module refers to a functional unit configured to perform anomaly determination on a target region.

In some embodiments, the anomaly discrimination module is configured to: obtain multi-source data of a plurality of road sections in the target region, the multi-source data including road image data, terminal report data, and sensor data; and perform the anomaly determination on the target region according to the multi-source data, and determine a plurality of hazard hot zones, at least one abnormal driving behavior, including sudden braking, sudden turning, or lane departure, existing in a plurality of hazard hot zones.

The diversion module refers to a functional unit configured to perform diversion for the plurality of hazard hot zones.

In some embodiments, the diversion module is configured to: for each of the plurality of hazard hot zones, determine a plurality of alternative routes according to a determination result of the anomaly determination and a regional road network topology map; determine primary recommended routes corresponding to a plurality of variable message signs according to the plurality of alternative routes and position information of the plurality of variable message signs, and generate a diversion instruction to send to the emergency supervision object platform, the diversion instruction including a schematic diagram of each of the plurality of alternative routes and a traffic cycle; and control each of the plurality of variable message signs to display a schematic diagram of a corresponding primary recommended route, and control traffic signal lights on the plurality of alternative routes to display green light signals according to the traffic cycle, based on the diversion instruction.

The emergency supervision sensor network platform 140 refers to a platform for comprehensively managing sensing information.

In some embodiments, the emergency supervision sensor network platform 140 may be configured as a communication device or a server for communication, such as a 5G base station, a Vehicle-to-Everything (V2X) roadside unit, an optical fiber switch, etc.

In some embodiments, the emergency supervision sensor network platform 140 may interact with the emergency supervision management platform 130 and the emergency supervision object platform 150.

The emergency supervision object platform 150 refers to a functional platform for generating perception information and executing control information.

In some embodiments, the emergency supervision object platform 150 may include a plurality of variable message signs, a plurality of traffic signal lights, a plurality of monitoring devices, a plurality of vehicle terminals, and a plurality of IoT sensors.

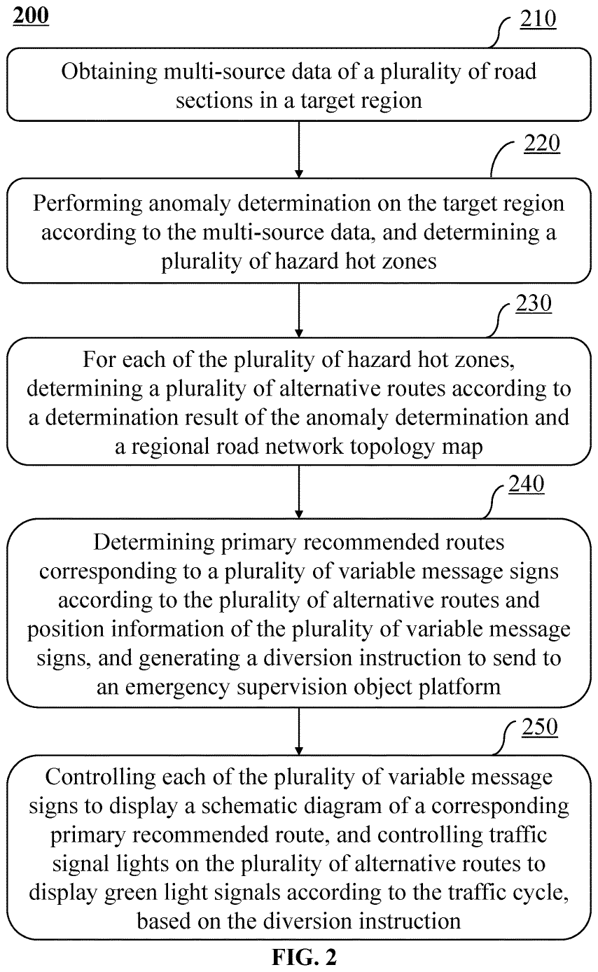

More detailed descriptions regarding the foregoing may be found in FIG. 2 to FIG. 4 and the relevant descriptions thereof.

In some embodiments of the present disclosure, the system 100 for performing emergency monitoring of traffic anomalies in a smart city based on the IoT large-scale model can establish an information operation closed loop among the functional platforms, thereby achieving informatized and smart emergency monitoring of traffic anomalies.

FIG. 2 is an exemplary flowchart illustrating a method for performing emergency monitoring of traffic anomalies in a smart city based on an Internet of Things (IoT) large-scale model according to some embodiments of the present disclosure. In some embodiments, a process 200 may be performed by an emergency supervision management platform (hereinafter referred to as a management platform) of a system for performing emergency monitoring of traffic anomalies in a smart city based on the IoT large-scale model. More details regarding the system for performing emergency monitoring of traffic anomalies in a smart city based on the IoT large-scale model and the emergency supervision management platform may be found in FIG. 1 and the relevant descriptions thereof.

As shown in FIG. 2, the process 200 includes the following operations.

In 210, multi-source data of a plurality of road sections in a target region may be obtained.

The target region refers to a region in which driving behaviors of vehicles need to be analyzed. For example, the target region may be a city, a region near a large shopping mall, etc.

The road sections refer to roads or paths within the target region, typically including information such as road name, start point, end point, length, etc. In some embodiments, the target region includes the plurality of road sections.

The multi-source data refers to data related to the target region obtained from different sources.

In some embodiments, the multi-source data includes road image data, terminal report data, and sensor data.

The road image data refers to image data of a plurality of vehicles on a road within a preset period. The preset period refers to a pre-set period of time, e.g., 3 minutes, 5 minutes, etc. The preset period may be set based on experience.

In some embodiments, the road image data may be obtained by a roadside camera. The roadside camera refers to a monitoring camera installed on or along sides of roads. The roadside camera includes a fixed high-definition camera, a pan-tilt-zoom camera, a lift-type camera, etc. The fixed high-definition camera is deployed at intersections and collapse-prone road sections to obtain all-weather road monitoring images. The pan-tilt-zoom camera or the lift-type camera may automatically move to a suspicious region (e.g., a waterlogged puddle) and perform auto-focusing when an alarm is triggered.

The terminal report data refers to data uploaded by a terminal. For example, the terminal report data includes vehicle driving data and driver report information within the preset period. The terminal includes a vehicle terminal, for example, an On-Board Diagnostics (OBD) system, a Telematics Box (T-Box), etc. The vehicle driving data refers to data related to vehicle operating status collected by the vehicle terminal, for example, GPS coordinates of the vehicle during sudden braking or sudden turning. The driver report information refers to abnormal information related to driving actively submitted by a driver via the vehicle terminal, for example, “obstacle ahead”, etc.

The sensor data refers to data related to physical environment or device status collected by sensors. For example, the sensor data includes road settlement data and waterlogging data within the preset period. The road settlement data includes road settlement height. The waterlogging data includes waterlogging depth. In some embodiments, the sensor data may be obtained by IoT sensors laid on the road surface. The IoT sensors include a geomagnetic sensor and a water level sensor. The geomagnetic sensor is buried in the road surface to monitor road settlement. The water level sensor is installed in a low-lying waterlogged region to monitor waterlogging depth.

In 220, anomaly determination may be performed on the target region according to the multi-source data, and a plurality of hazard hot zones may be determined.

The anomaly determination refers to a process of identifying abnormal phenomena or potential risks inconsistent with normal conditions through analysis of the multi-source data.

In some embodiments, the management platform may perform the anomaly determination on the target region according to the multi-source data through a plurality of ways to obtain a determination result. For example, the management platform may extract a plurality of vehicle driving trajectories and speed variation data from the road image data by using an image recognition algorithm. If at least one of a sudden change in direction in one of the plurality of vehicle driving trajectories or a sudden change in speed (e.g., sudden stopping) in the speed variation data occurs, at least one of a position where the sudden change in direction occurs or a position where the sudden change in speed occurs is recorded as an image anomaly position point.

As another example, the management platform may record GPS coordinates when the driver reports information and the GPS coordinates of the vehicle during the sudden braking or the sudden turning automatically reported by the terminal as report anomaly position points based on the terminal report data. As yet another example, the management platform may analyze the sensor data. If the road settlement height or the waterlogging depth exceeds a corresponding preset anomaly threshold, the position of the corresponding sensor is recorded as a sensor anomaly position point.

The management platform may use a union of the image anomaly position point, the report anomaly position points, and the sensor anomaly position point as the determination result.

The determination result includes a plurality of anomaly position points within the target region.

The image recognition algorithm refers to an algorithm that analyzes image data or video data through computer vision technology to extract information therefrom. For example, the image recognition algorithm includes a Haar feature detection, a convolutional neural network, or the like.

The vehicle driving trajectories refer to motion paths of the vehicle on the road, typically described by positions of the vehicle at consecutive time points (e.g., the GPS coordinates or pixel coordinates in an image).

The speed variation data refers to a speed sequence of the vehicle within the preset period.

The preset anomaly threshold refers to a preset critical value for the road settlement height or the waterlogging depth. The preset anomaly threshold may be set based on experience.

The hazard hot zones refer to regions where traffic operating status has clearly deviated from a safe normal condition within the preset period. The deviation from the safe normal condition includes the occurrence of a traffic anomaly, a risk sign, etc.

The traffic anomaly refers to an event or state that has actually occurred and be able to be observed within the hazard hot zones. For example, the traffic anomaly includes a vehicle driving anomaly, an infrastructure anomaly, or the like. The vehicle driving anomaly includes the sudden braking, the sudden turning, sudden acceleration, abnormal U-turn, or the like. The infrastructure anomaly includes aging, damage, failure, road surface waterlogging, traffic signal light malfunction, or the like, in the road, an overpass, a tunnel, etc.

The risk sign refers to a quantifiable leading indicator or environmental condition presented within the hazard hot zones before the occurrence of the traffic anomaly. For example, the risk sign includes a traffic flow instability sign, a system overload sign, an environment and external risk sign, etc. The traffic flow instability sign includes a continuous decrease in an average vehicle speed on the road section, an increase in speed differences between vehicles, etc. The system overload sign includes real-time traffic flow oversaturation, excessively high traffic density, etc. The environment and external risk sign includes deteriorating weather conditions, poor lighting conditions, or the like.

In some embodiments, at least one of the abnormal driving behaviors, such as the sudden braking, the sudden turning, and the lane departure, exists within the plurality of hazard hot zones.

In some embodiments, after performing the anomaly determination on the target region and obtaining the determination result, the management platform may uniformly divide the target region into a plurality of sub-regions. For each sub-region, the management platform determines a count of anomaly occurrences within the sub-region during the preset time period based on the determination result, and designates the sub-region in which the count of anomaly occurrences exceeds a preset frequency threshold as the hazard hot zone. The preset frequency threshold may be set based on experience. The management platform may use a count of the anomaly position points in the determination result as the count of anomaly occurrences.

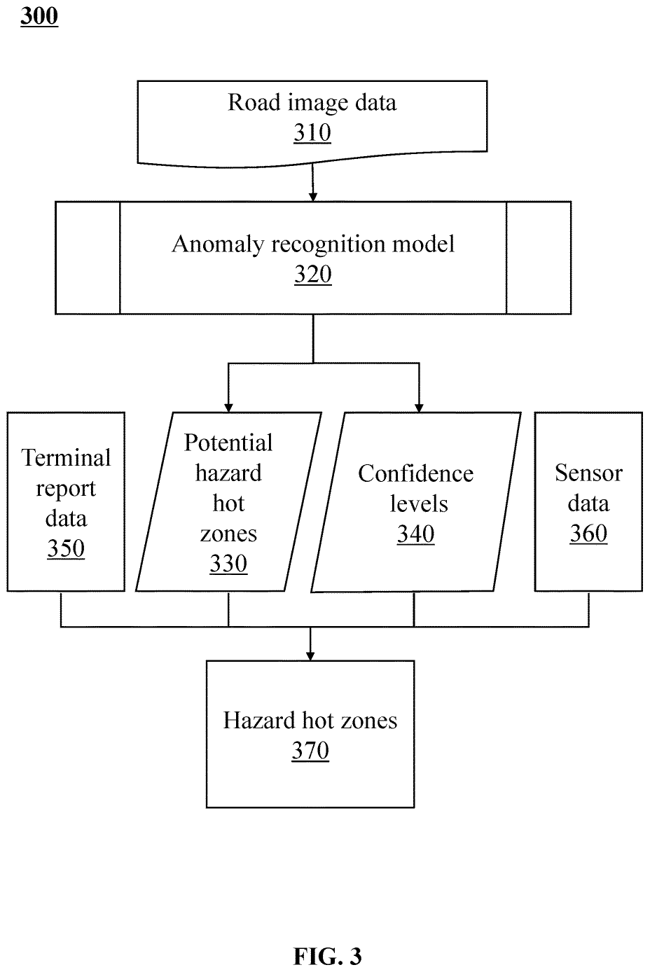

In some embodiments, the management platform may perform the anomaly determination on the target region and determine a plurality of potential hazard hot zones and confidence levels corresponding to the plurality of potential hazard hot zones according to the road image data through an anomaly recognition model. More details regarding the part may be found in FIG. 3 and the relevant descriptions thereof.

In 230, for each of the plurality of hazard hot zone, a plurality of alternative routes may be determined according to the determination result of the anomaly determination and a regional road network topology map.

The regional road network topology map refers to a graphical representation describing the road network structure within the target region. In some embodiments, the regional road network topology map is a directed graph, including nodes and edges. The nodes represent position points such as an intersection, a road end point, or a position where a road attribute (e.g., a road speed limit, a road type) changes. The road type includes an ordinary road, an overpass, a highway, etc. The edges represent road sections connecting two nodes. In some embodiments, if the road section connecting two nodes is a one-way street, a direction of the edge aligns with a traffic flow direction. If the road section connecting two nodes supports two-way traffic and includes a plurality of lanes, a plurality of edges exist between the two nodes, each edge corresponding to the lane, and a direction of each edge aligns with a traffic flow direction of the each lane. An attribute of each edge is a lane identifier, for example, “leftmost lane 1”, or the like.

The alternative routes refer to alternative travel paths provided for the vehicle when a hazard (e.g., a traffic accident, construction, congestion, or other abnormal conditions) occurs in the sub-region or the road section.

In some embodiments, for each of the plurality of hazard hot zones, the management platform may determine the plurality of alternative routes in a plurality of ways according to the determination result of the anomaly determination and the regional road network topology map. For example, the management platform determines a plurality of edges and nodes in the regional road network topology map that contain the anomaly position points based on the anomaly determination result. For each of the plurality of hazard hot zones, the management platform obtains a plurality of nodes corresponding to the hazard hot zone in the regional road network topology map, i.e., a plurality of nodes within the hazard hot zone. For each node within the hazard hot zone, if there exist edges pointing to the node that are connected to nodes outside the hazard hot zone, the management platform obtains a plurality of edges pointing to the node and a plurality of nodes outside the hazard hot zone that are connected to the aforementioned plurality of edges (hereinafter referred to as first target nodes), uses one of the plurality of first target nodes as a starting point and selects one of the nodes (hereinafter referred to as second target nodes) within the hazard hot zone that is aligned on a straight line extending from the first target node through the hazard hot zone and is connected to the hazard hot zone as the end point. The management platform then applies a preset algorithm to obtain a shortest path from the first target node to the selected end point that bypasses the corresponding hazard hot zone, and designates the shortest path as the alternative route. For a plurality of second target nodes corresponding to the first target node, the management platform repeats the computation of the shortest path to obtain a plurality of alternative routes corresponding to the first target node. For the plurality of first target nodes connected to the aforementioned plurality of edges, the management platform repeatedly selects different second target nodes, and performs the computation of the shortest path to obtain the plurality of alternative routes corresponding to the plurality of first target nodes. For the plurality of nodes included in the hazard hot zone, the management platform repeatedly obtains the plurality of edges pointing to the nodes, selects different first target nodes, chooses different second target nodes, and performs the computation of shortest path to obtain the plurality of alternative routes corresponding plurality of alternative routes corresponding to the hazard hot zone. The phrase “connected by a straight line extending from the first target node through the hazard hot zone and connected to the hazard hot zone” means that the straight line from the first target node to the end point passes through the hazard hot zone, but the selection of the end point bypasses the hazard hot zone because the end point is a node connected to the hazard hot zone, not a node located within the hazard hot zone. The preset algorithm includes a shortest path planning algorithm, e.g., Dijkstra's Shortest Path (Dijkstra) algorithm, Bellman-Ford Shortest Path (Bellman-Ford) algorithm, etc.

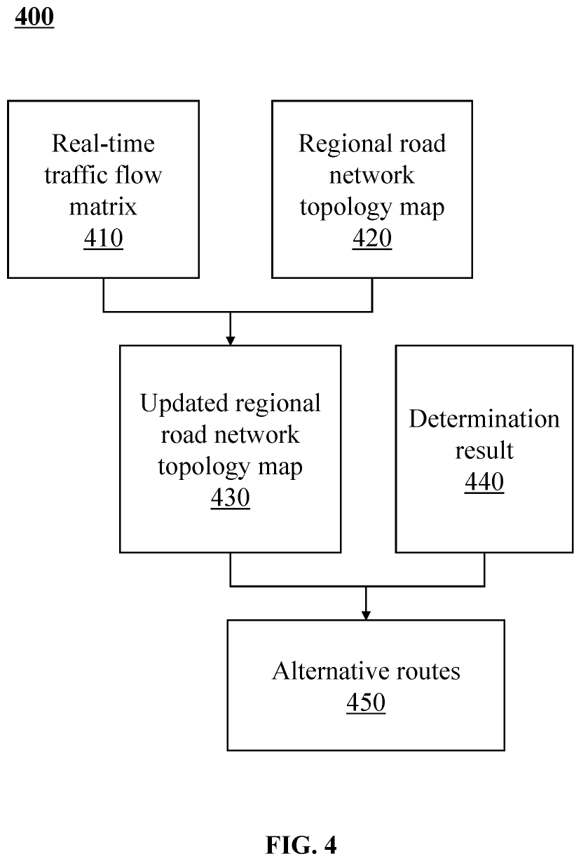

In some embodiments, the management platform may determine the plurality of alternative routes based on the updated regional road network topology map and the determination result of the anomaly determination. More details regarding the part may be found in FIG. 4 and the relevant descriptions thereof.

In 240, primary recommended routes corresponding to a plurality of variable message signs may be determined according to the plurality of alternative routes and position information of the plurality of variable message signs, and a diversion instruction may be generated to send to the emergency supervision object platform.

More details regarding the emergency supervision object platform may be found in FIG. 1 and the relevant descriptions thereof.

The variable message signs refer to a digital roadside device that dynamically displays traffic information through a smart control system. The variable message signs are primarily configured to broadcast real-time information such as road conditions, weather, and traffic control measures, guiding the driver to select an optimal route.

The position information of the plurality of variable message signs refers to specific distribution points of the plurality of variable message signs within the road network. For example, the position information of the plurality of variable message signs includes GPS coordinates of the plurality of variable message signs. The GPS coordinates of the plurality of variable message signs are determined when the plurality of variable message signs are installed.

The primary recommended routes refer to routes displayed on the variable message signs.

In some embodiments, based on the plurality of alternative routes and the position information of the plurality of variable message signs, the management platform may determine the primary recommended routes for the plurality of variable message signs in a plurality of ways. For example, for each variable message sign, the management platform selects, among all alternative routes that pass through a given variable message sign, the route with a shortest total length as the primary recommended route for the variable message sign. In some embodiments, the primary recommended route guides the driver to bypass the hazard hot zone at a fastest speed, avoiding congestion.

The diversion instruction refers to a traffic management instruction configured to optimize traffic flow distribution, alleviate congestion, or respond to emergencies. In some embodiments, the diversion instruction includes a schematic diagram of each of the plurality of alternative routes and a traffic cycle. The schematic diagram of each of the plurality of alternative routes refers to a graphical representation of each of the plurality of alternative routes.

In some embodiments, the schematic diagram of each of the plurality of alternative routes is obtained by visualizing the alternative route on a traffic network graph and representing alignment and key nodes of the alternative route using simplified graphical elements, such as a line, an arrow, a node marker, etc.

The traffic cycle refers to a traffic cycle of the traffic signal light, i.e., the time required for the traffic signal light to complete one full signal change (typically including a red light, a green light, and a yellow light).

In some embodiments, the management platform may obtain a plurality of traffic signal lights included in the plurality of alternative routes, and generate the diversion instruction by adjusting the traffic cycles of the plurality of traffic signal lights. For example, the adjustment includes reducing a preset adjustment amount for the traffic cycle (i.e., increasing a frequency of the green light). The preset adjustment amount may be set based on experience.

In 250, each of the plurality of variable message signs may be controlled to display a schematic diagram of a corresponding primary recommended route, and traffic signal lights on the plurality of alternative routes may be controlled to display green light signals according to the traffic cycle, based on the diversion instruction.

The schematic diagram of the primary recommended route refers to a graphical representation of the primary recommended route. A way for obtaining the schematic diagram of the primary recommended route is similar to the way for obtaining the schematic diagram of each of the plurality of alternative routes and may be found in the foregoing descriptions.

In some embodiments, after the diversion instruction is determined, the management platform controls the plurality of variable message signs to display the schematic diagrams of the corresponding primary recommended routes, and controls the traffic signal lights on the plurality of alternative routes to display the green light signals according to the traffic cycle.

In some embodiments of the present disclosure, multi-source data is acquired through the cameras, the vehicle terminals, and the road surface sensors, enabling comprehensive perception of vehicle trajectories and road conditions. By analyzing vehicle trajectories to identify potential risks, the accuracy of the anomaly determination can be ensured. Upon confirmation of hazards, an optimal detour plan is dynamically generated based on real-time traffic conditions, and traffic flow is actively guided through vehicle-based prompts, traffic signal control, or the like, thereby ensuring road safety and smooth traffic flow.

It should be noted that the description of the aforementioned process 200 is merely for illustration and explanation and does not limit the scope of application of the present disclosure. For those skilled in the art, a plurality of modifications and changes to process 200 may be made under the guidance of the present disclosure. However, these modifications and changes remain within the scope of the present disclosure.

FIG. 3 is a schematic diagram illustrating an exemplary process for determining a plurality of hazard hot zones according to some embodiments of the present disclosure.

In some embodiments, as shown in FIG. 3, the management platform performs anomaly determination on a target region and determines a plurality of potential hazard hot zones 330 and confidence levels 340 corresponding to the plurality of potential hazard hot zones 330 according to road image data 310 through an anomaly recognition model 320; and determines the plurality of hazard hot zones 370 according to terminal report data 350, sensor data 360, the plurality of potential hazard hot zones 330, and the confidence levels 340 corresponding to the plurality of potential hazard hot zones 330.

More details regarding the road image data, the target region, the terminal report data, the sensor data, and the hazard hot zones may be found in FIG. 2 and the relevant descriptions thereof.

The anomaly recognition model refers to a model configured to determine the potential hazard hot zones and the potential hazard hot zone corresponding to the confidence level. In some embodiments, the anomaly recognition model is a machine learning model. For example, the anomaly recognition model is a Recurrent Neural Network (RNN), a Deep Neural Network (DNN), etc.

The potential hazard hot zones refer to possibly existing hazard hot zones.

The confidence levels refer to reliability of the determination result of the anomaly recognition model for one of the plurality of potential hazard hot zones, typically represented as percentages or probability values.

In some embodiments, the anomaly recognition model includes an anomaly recognition layer and a region recognition layer.

The anomaly recognition layer refers to a model layer configured to perform the anomaly determination on the target region. For example, the anomaly recognition layer is a Long Short-Term Memory (LSTM) network, etc.

The region recognition layer refers to a model layer configured to determine the potential hazard hot zones. For example, the region recognition layer is a Deep Neural Network (DNN), etc.

In some embodiments, an input of the anomaly recognition layer is the road image data, and an output includes a trajectory anomaly score for each sub-region, a plurality of potential obstacle points, and a plurality of trajectory anomaly features. An input of the region recognition layer includes the trajectory anomaly score for each sub-region, the plurality of potential obstacle points within the sub-region, and the plurality of trajectory anomaly features, and an output includes the plurality of potential hazard hot zones and the confidence levels corresponding to the plurality of potential hazard hot zones.

The trajectory anomaly score refers to overall anomaly degree of vehicle driving trajectories within the sub-region over a preset period. For example, the trajectory anomaly score may be represented by a number from 0 to 5. The larger number indicates the higher anomaly degree of the vehicle driving trajectory within the sub-region. The potential obstacle points refer to position points within the sub-region where infrastructure anomalies may exist, preventing normal vehicle passage. The trajectory anomaly features refer to anomaly types of the vehicle driving trajectories at the plurality of potential obstacle points within the sub-region, e.g., occurrence of loss of control and skidding, sudden turning, sudden braking, etc. More details regarding the preset time period may be found in FIG. 2 and the relevant descriptions thereof.

In some embodiments, training of the anomaly recognition model may be performed by separately training the anomaly recognition layer and the region recognition layer.

In some embodiments, the anomaly recognition layer and the region recognition layer may be obtained through training in a plurality of ways. For example, the anomaly recognition layer may be trained using a large number of first training samples with first labels via a gradient descent algorithm. The region recognition layer may be trained using a large number of second training samples with second labels via the gradient descent algorithm.

In some embodiments, the management platform may collect a plurality of pieces of historical road image data from a plurality of historical time periods as the first training samples; and designate historical trajectory anomaly scores, a plurality of historical obstacle points, and a plurality of historical trajectory anomaly features corresponding to each actual sub-region in each of the plurality of pieces of historical road image data as the first labels corresponding to the first training samples.

The historical obstacle points refer to positions in a region or a road section at a historical time where an infrastructure anomaly actually existed, causing the vehicle to be unable to pass normally. The management platform may obtain a plurality of points undergoing maintenance on historical roads as a plurality of actual historical obstacle points based on historical road maintenance data. The historical road maintenance data refers to data related to road maintenance performed during historical time, including filling cracks, clearing accumulated water, etc.

The historical trajectory anomaly scores and the plurality of historical trajectory anomaly features in each actual sub-region may be obtained through the following operations: determining the historical trajectory anomaly scores and the historical trajectory anomaly features corresponding to each piece of historical road image data based on manual annotation; determining the historical trajectory anomaly score for the sub-region based on an average of the historical trajectory anomaly scores of the plurality of pieces of historical road image data within the sub-region; aggregating a plurality of historical trajectory anomaly features of the plurality of pieces of historical road image data within each sub-region as the plurality of historical trajectory anomaly features of the sub-region.

Merely by way of example, the management platform may input the first training samples into an initial anomaly recognition layer to obtain an output of the initial anomaly recognition layer; construct a loss function based on the output of the initial anomaly recognition layer and the first labels; iteratively update parameters of the initial anomaly recognition layer based on a value of the loss function; and until an iteration termination condition is satisfied, complete training to obtain a trained anomaly recognition layer. The iteration termination condition includes convergence of the loss function, a count of iterations reaching a threshold, or the like.

In some embodiments, the management platform may collect, for a plurality of historical sub-regions, historical trajectory anomaly scores, a plurality of historical trajectory anomaly features, and a plurality of historical obstacle points as the second training samples; and designate whether historical sub-regions are subsequently identified as the historical hazard hot zone, along with the corresponding historical confidence level when the historical sub-regions are identified as the historical hazard hots zones as the second labels corresponding to the second training samples.

Whether the historical sub-regions are subsequently identified as the historical hazard hot zones may be determined through the following operations: if a count of traffic accidents or infrastructure failures occurring in the historical sub-region during a subsequent time period exceeds a preset count threshold, the historical sub-region is determined to be the historical hazard hot zone; otherwise, the historical sub-region is determined not to be the historical hazard hot zone. Correspondingly, the management platform may determine a difference between the count of traffic accidents or infrastructure failures occurring in the historical sub-region and the preset count threshold when the historical sub-region is determined to be the historical hazard hot zone, and use a ratio of the difference to the preset count threshold as the historical confidence level. The preset count threshold may be set based on experience.

A training process of the region recognition layer is similar to the training process of the anomaly recognition layer and may be found in the foregoing descriptions.

In some embodiments, the management platform determines the plurality of hazard hot zones in a plurality of ways according to the terminal report data, the sensor data, the plurality of potential hazard hot zones, and the confidence levels corresponding to the plurality of potential hazard hot zones. For example, for each potential hazard hot zone, the management platform may obtain the terminal report data and the sensor data corresponding to a plurality of potential obstacle points within the potential hazard hot zone. For each potential obstacle point, if the terminal report data or the sensor data corresponding to the potential obstacle point matches the trajectory anomaly features associated therewith, a confirmed anomaly count of the potential hazard hot zone is incremented by one. If a sum of the confirmed anomaly count and the confidence level of the potential hazard hot zone exceeds a preset confidence threshold, the management platform may identify the potential hazard hot zone as the hazard hot zone. Whether the data matches the trajectory anomaly features may be determined based on a first preset table. The management platform queries the first preset table based on the terminal report data and the sensor data to obtain a corresponding anomaly type indicated in the first preset table. If the anomaly type is the same as an anomaly type in the trajectory anomaly feature of the potential obstacle point, the match is confirmed. The first preset table refers to a table including a correspondence between anomaly types and the terminal report data and the sensor data. The first preset table is set based on experience. The preset confidence threshold is set based on experience.

In some embodiments, the management platform may generate a monitoring control instruction through a first vector database according to the plurality of potential obstacle points and trajectory anomaly features corresponding to the plurality of potential obstacle points output by the anomaly recognition model; and control a monitoring device to adjust to a monitoring angle and perform image acquisition at a monitoring focal distance, based on the monitoring control instruction.

The first vector database includes a plurality of feature vectors and labels corresponding to the plurality of feature vectors. Merely by way of example, the management platform may construct the plurality of feature vectors based on the plurality of historical obstacle points and the historical trajectory anomaly features corresponding to the plurality of historical obstacle points, and designate preferred monitoring control instructions corresponding to the plurality of feature vectors as the labels corresponding to the plurality of feature vectors. The preferred monitoring control instructions may be obtained by selecting the historical monitoring control instructions with the best monitoring effect from a plurality of historical monitoring corresponding to the plurality of feature vectors. The best monitoring effect refers to image data obtained that has the highest coverage of the historical obstacle points and the least amount of obstructions.

The monitoring control instruction refers to an operation instruction for controlling the monitoring device.

In some embodiments, the monitoring control instruction includes the monitoring angle and the monitoring focal distance.

The monitoring angle refers to a shooting angle at which a pan-tilt-zoom camera or a lift-type camera captures images of a plurality of potential obstacle points. In some embodiments, the monitoring angle is a range of values, and the monitoring device performs panning or oscillating capture within the range to obtain a plurality of image data from different angles.

The monitoring focal distance refers to a shooting focal distance at which the pan-tilt-zoom camera or the lift-type camera shoots the plurality of potential obstacle points.

In some embodiments, the management platform constructs a target vector based on the current potential obstacle point and the trajectory anomaly feature corresponding to the current potential obstacle point, matches the target vector with the plurality of feature vectors in the first vector database, and determines a plurality of similarity scores between the target vector and the plurality of feature vectors. The management platform selects the feature vector having the highest similarity score to the target vector and uses the label corresponding to the selected feature vector as the monitoring control instruction corresponding to the target vector. The similarity score may be represented in a plurality of ways, such as Euclidean distance, cosine similarity, or the like.

The monitoring device refers to a device configured to monitor the potential obstacle point. For example, the monitoring device includes the pan-tilt-zoom camera, the lift-type camera, etc.

In some embodiments, the management platform controls the pan-tilt-zoom camera or the lift-type camera to move to a monitoring position corresponding to each potential obstacle point and performs image acquisition at the corresponding monitoring angle and monitoring focal distance, based on the monitoring control instruction. The monitoring position corresponding to the potential obstacle point refers to a projection position of the potential obstacle point onto the roadside.

In some embodiments, the management platform may further generate a first lane change instruction according to the plurality of potential obstacle points, a position of the monitoring device, and the monitoring angle; and controls a corresponding vehicle terminal to perform a lane-changing prompt based on the first lane change instruction, to make a vehicle drive away from a line-of-sight obstruction region of the monitoring device.

The position of the monitoring device refers to a position to which the monitoring device needs to move to monitor the potential obstacle point, i.e., the monitoring position corresponding to the potential obstacle point.

The line-of-sight obstruction region of the monitoring device refers to a region that the monitoring device is not capable of directly observing due to certain obstacles or environmental factors. For example, the line-of-sight obstruction region of the monitoring device includes a region formed by a line connecting the monitoring angle of the monitoring device at the monitoring position and the potential obstacle point.

The first lane change instruction refers to an instruction prompting the vehicle to change lanes. The first lane change instruction may be a voice reminder, e.g., “Please change to the left lane”, etc.

In some embodiments, the management platform may further generate the first lane change instruction in a plurality of ways based on the plurality of potential obstacle points, the position of the monitoring device, and the monitoring angle. For example, for each potential obstacle point, the management platform determines the line-of-sight obstruction region of the monitoring device based on the position of the monitoring device and the monitoring angle. When the vehicle is detected to be approaching the line-of-sight obstruction region within a preset time range, the management platform may comprehensively evaluate safety information, confirm that a lane change is feasible, and then generate and send the first lane change instruction to alert the vehicle to leave the current lane, thereby preventing the vehicle from obstructing monitoring view of the monitoring device. The preset time range refers to a preset period of time, for example, 10 minutes before entry, 20 minutes before entry, etc.

The safety information refers to information related to safety of the lane change. For example, the safety information includes availability of a target lane, a speed, and a position of the current vehicle, a reaction time of the driver, etc. The safety information may be obtained in a plurality of ways. For example, the management platform obtains the availability of the target lane and the current speed and a position of the vehicle through a vehicle terminal. As another example, the management platform obtains historical driving data through the vehicle terminal and determines the reaction time of the driver by analyzing the historical driving data. The target lane refers to a lane that the vehicle is about to turn into. The historical driving data refers to data related to a driving behavior of the current driver. In some embodiments, the management platform confirms that the lane change is feasible after verifying that the target lane is available, that the current vehicle speed and the position allow completion of the lane change, and that the driver has sufficient reaction time.

In some embodiments, the preset time range may be determined in a plurality of ways. For example, the preset time range may be set based on experience.

In some embodiments, the management platform may adjust a sending time of the first lane change instruction according to an average vehicle gap on a plurality of lanes.

The average vehicle gap refers to an average gap between adjacent vehicles on the plurality of lanes of a road section where the potential obstacle point is located, for example, 3 m, 4 m, etc.

The sending time of the first lane change instruction is a dynamically adjusted process. A core objective of the process is to optimize lane change timing under the premise of ensuring safety, thereby improving traffic efficiency and driver experience.

In some embodiments, the sending time of the first lane change instruction may be obtained based on a difference between an estimated time of arrival at the line-of-sight obstruction region and the preset time range. The estimated time of arrival at the line-of-sight obstruction region may be determined based on a current vehicle speed and a distance between a current position and the line-of-sight obstruction region. The current vehicle speed and the current position may be obtained based on the vehicle terminal. More details regarding the preset time range may be found in the foregoing descriptions.

In some embodiments, the management platform may adjust the sending time of the first lane change instruction based on the average vehicle gap on the plurality of lanes through a second preset table. The second preset table refers to a table that includes a correspondence relationship between the average vehicle gap and the preset time range. The management platform may determine the preset time range by querying the second preset table based on the average vehicle gap, and then determine the sending time of the first lane change instruction based on the current vehicle speed and the preset time range. The second preset table may be set based on experience.

In some embodiments of the present disclosure, adjusting the sending time of the first lane change instruction based on the average vehicle gap enables early notification to drivers when traffic density is high, thereby facilitating advance lane changes and avoiding congestion caused by last-minute maneuvers.

In some embodiments of the present disclosure, when capturing data regarding the potential obstacle points, the first lane change instruction is issued to alert the vehicle to leave the monitoring region, thereby preventing the vehicle from obstructing the monitoring region and improving the completeness of the acquired monitoring images.

In some embodiments of the present disclosure, based on the potential obstacle points and the trajectory anomaly features output by the anomaly recognition model, the monitoring device is able to dynamically adjust the monitoring angle and the monitoring focal distance in real time to ensure that the target region is captured clearly and accurately. By adjusting the monitoring angle, the system is able to effectively reduce or eliminate the line-of-sight obstruction region, thereby avoiding monitoring blind spots caused by occlusion from obstacles.

In some embodiments of the present disclosure, the anomaly recognition model performs multi-dimensional comprehensive analysis to improve the accuracy of the anomaly determination by integrating the road image data, the terminal report data, and the sensor data. Processing complex data through the machine learning model enables the identification of anomalous patterns that are difficult to detect using conventional manners, thereby enhancing detection capability. The anomaly recognition model precisely locates the potential hazard hot zones within the target region and clearly identifies regions where risks are concentrated.

FIG. 4 is a schematic diagram illustrating an exemplary process for determining a plurality of alternative routes according to some embodiments of the present disclosure.

In some embodiments, as shown in FIG. 4, the management platform may update a regional road network topology map 420 according to a real-time traffic flow matrix 410, and determine the plurality of alternative routes 450 according to an updated regional road network topology map 430 and a determination result 440 of anomaly determination.

More details regarding the regional road network topology map, the determination result, and the plurality of alternative routes may be found in FIG. 2 and the relevant descriptions thereof.

The real-time traffic flow matrix refers to a data structure that indicates how many vehicles travel from one node (a starting point) to another node (an end point) within a preset time period. The node refers to a node of the regional road network topology map. In the real-time traffic flow matrix, a row represents an origin, a column represents the end point, and a value in each cell represents vehicle volume from the origin corresponding to the row to the end point corresponding to the column. More details regarding the preset time period may be found in FIG. 1 and the relevant descriptions thereof.

In some embodiments, based on the real-time traffic flow matrix, the management platform adds the vehicle volume to edge attributes of the regional road network topology map. For a plurality of edges corresponding to the plurality of lanes traveling in a same direction on a same road section, the management platform evenly distributes the vehicle volume of the road section among the plurality of edges, thereby obtaining the updated regional road network topology map.

In some embodiments, a way for determining the plurality of alternative routes based on the updated regional road network topology map and the determination result is similar to the way for determining the plurality of alternative routes based on the regional road network topology map and the determination result, as described previously. The difference between the two lies in that each edge in the updated regional road network topology map is assigned a dynamic weight, and during the computation of a shortest path, a preset algorithm preferentially selects edges with a lower weight.

A weight value of the dynamic weight is determined based on the vehicle volume on each road section. Merely by way of example, the weight value may be represented by a ratio of a weight coefficient to the vehicle volume of the road section. The weight coefficient is a preset constant set based on experience. The vehicle volume of the road section refers to a count of vehicles passing through the road section within the preset time period.

In some embodiments, the management platform determines recommended priorities of the plurality of alternative routes according to the updated regional road network topology map; and sends the plurality of alternative routes to corresponding vehicle terminals according to the recommended priorities.

The recommended priorities refer to priority orders in which the alternative routes are recommended. For example, the recommended priorities may be represented by a number from 0 to 1. A smaller number indicates that a corresponding alternative route is recommended earlier.

In some embodiments, the management platform may determine the recommended priorities of the plurality of alternative routes according to the updated regional road network topology map in a plurality of ways. For example, the management platform may determine an average of the vehicle volume across a plurality of road sections for each alternative route; based on the average of the vehicle volume of the plurality of alternative routes, sort the alternative routes in ascending order, and use a resulting rank as the recommendation priority for each alternative route.

The vehicle terminal, also referred to as an onboard terminal, may be found in the foregoing descriptions.

In some embodiments, according to the recommendation priorities, the management platform assigns priority labels to the plurality of alternative routes, and when the vehicle terminal displays the plurality of alternative routes, the vehicle terminal simultaneously displays priority markers of the alternative routes.

In some embodiments of the present disclosure, determining the priorities of alternative routes based on the vehicle volume helps prevent a large number of vehicles from entering routes with high vehicle volume, thereby avoiding congestion.

In some embodiments, the management platform may further determine a second lane-changing instruction according to the updated regional road network topology map and a plurality of potential obstacle points, and control a corresponding vehicle terminal to perform a lane-changing prompt based on the second lane-changing instruction.

More details regarding the plurality of potential obstacle points may be found in FIG. 3 and the relevant descriptions thereof.

In some embodiments, the plurality of potential obstacle points are determined based on an anomaly recognition model.

More details regarding determining the plurality of potential obstacle points based on the anomaly recognition model may be found in FIG. 3 and the relevant descriptions thereof.

The second lane-changing instruction refers to a lane-changing prompt instruction sent before the vehicle is about to enter a new road section.

In some embodiments, the management platform may determine the second lane-changing instruction according to the updated regional road network topology map and the plurality of potential obstacle points in a plurality of ways. For example, the management platform may determine a plurality of road sections with the vehicle volume exceeding a preset flow threshold based on the updated regional road network topology map. For each road section whose vehicle volume exceeds the preset flow threshold, if the potential obstacle point exists on the road section, the management platform determines a plurality of lanes in which the potential obstacle point is located and determines the road section as a section requiring early avoidance. When the vehicle is about to enter the section requiring early avoidance, the second lane-changing instruction is generated to prompt the vehicle to avoid the plurality of lanes containing the potential obstacle point. The preset flow threshold may be set based on experience.

In some embodiments of the present disclosure, for the routes with high vehicle volume that contain the potential obstacle points, prompting the vehicle to perform early lane changes can effectively prevent traffic accidents caused by the inability to change lanes in time to avoid fault positions due to excessive vehicle volume.

In some embodiments of the present disclosure, a dynamic updating mechanism based on the real-time traffic flow matrix enables the system to rapidly respond to changes in traffic conditions and adapt to a plurality of scenarios, such as a peak hour, a sudden incident, or adverse weather. By continuously updating the road network topology map, the system can dynamically adjust the allocation of traffic resources, for example, by guiding the vehicle away from congested segments to alleviate traffic pressure. Simultaneously, users receive more timely and reliable route recommendations, reducing travel delays caused by congestion or unexpected events.

Furthermore, the particular features, structures, or characteristics may be combined as suitable in one or more embodiments of the present disclosure.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

What is claimed is:

1. A system for performing emergency monitoring of traffic anomalies in a smart city based on an Internet of Things (IoT) large-scale model, comprising an emergency supervision management platform and an emergency supervision object platform; wherein the emergency supervision management platform includes an anomaly discrimination module and a diversion module;
the anomaly discrimination module is configured to:
obtain multi-source data of a plurality of road sections in a target region, wherein the multi-source data includes road image data, terminal report data, and sensor data;
perform anomaly determination on the target region according to the multi-source data, and determine a plurality of hazard hot zones, wherein at least one abnormal driving behavior, including sudden braking, sudden turning, or lane departure, exists in the plurality of hazard hot zones;
the diversion module is configured to:
for each of the plurality of hazard hot zones,
determine a plurality of alternative routes according to a determination result of the anomaly determination and a regional road network topology map;
determine primary recommended routes corresponding to a plurality of variable message signs according to the plurality of alternative routes and position information of the plurality of variable message signs, and generate a diversion instruction to send to the emergency supervision object platform, wherein the diversion instruction includes a schematic diagram of each of the plurality of alternative routes and a traffic cycle; and
control each of the plurality of variable message signs to display a schematic diagram of a corresponding primary recommended route, and control traffic signal lights on the plurality of alternative routes to display green light signals according to the traffic cycle, based on the diversion instruction.

2. The system of claim 1, wherein the anomaly discrimination module is further configured to:
perform the anomaly determination on the target region and determine a plurality of potential hazard hot zones and confidence levels corresponding to the plurality of potential hazard hot zones according to the road image data through an anomaly recognition model, wherein the anomaly recognition model is a machine learning model; and
determine the plurality of hazard hot zones according to the terminal report data, the sensor data, the plurality of potential hazard hot zones, and the confidence levels corresponding to the plurality of potential hazard hot zones.

3. The system of claim 2, wherein the anomaly discrimination module is further configured to:
generate a monitoring control instruction through a first vector database according to a plurality of potential obstacle points and trajectory anomaly features corresponding to the plurality of potential obstacle points output by the anomaly recognition model, wherein the monitoring control instruction includes a monitoring angle and a monitoring focal distance; and
control a monitoring device to adjust to the monitoring angle and perform image acquisition at the monitoring focal distance, based on the monitoring control instruction.

4. The system of claim 3, wherein the anomaly discrimination module is further configured to:
generate a first lane change instruction according to the plurality of potential obstacle points, a position of the monitoring device, and the monitoring angle; and
control a corresponding vehicle terminal to perform a lane-changing prompt based on the first lane change instruction, to make a vehicle drive away from a line-of-sight obstruction region of the monitoring device.

5. The system of claim 4, wherein the anomaly discrimination module is further configured to:
adjust a sending time of the first lane change instruction according to an average vehicle gap on a plurality of lanes.

6. The system of claim 1, wherein the diversion module is further configured to:
update the regional road network topology map according to a real-time traffic flow matrix; and
determine the plurality of alternative routes according to an updated regional road network topology map and the determination result of the anomaly determination.

7. The system of claim 6, wherein the diversion module is further configured to:
determine recommended priorities of the plurality of alternative routes according to the updated regional road network topology map; and
send the plurality of alternative routes to corresponding vehicle terminals according to the recommended priorities.

8. The system of claim 6, wherein the diversion module is further configured to:
determine a second lane-changing instruction according to the updated regional road network topology map and a plurality of potential obstacle points; and
control a corresponding vehicle terminal to perform a lane-changing prompt based on the second lane-changing instruction.

9. The system of claim 8, wherein the plurality of potential obstacle points are determined based on an anomaly recognition model.

10. A method for performing emergency monitoring of traffic anomalies in a smart city based on an Internet of Things (IoT) large-scale model, wherein the method is executed by an emergency supervision management platform of a system for performing emergency monitoring of traffic anomalies in a smart city based on the IoT large-scale model, and the method comprises:
obtaining multi-source data of a plurality of road sections in a target region, wherein the multi-source data includes road image data, terminal report data, and sensor data;
performing anomaly determination on the target region according to the multi-source data, and determining a plurality of hazard hot zones, wherein at least one abnormal driving behavior, including sudden braking, sudden turning, or lane departure, exists in the plurality of hazard hot zones;
for each of the plurality of hazard hot zones,
determining a plurality of alternative routes according to a determination result of the anomaly determination and a regional road network topology map;
determining primary recommended routes corresponding to a plurality of variable message signs according to the plurality of alternative routes and position information of the plurality of variable message signs, and generating a diversion instruction to send to an emergency supervision object platform, wherein the diversion instruction includes schematic diagrams of the plurality of alternative routes and a traffic cycle; and
controlling each of the plurality of variable message signs to display a schematic diagram of a corresponding primary recommended route, and controlling traffic signal lights on the plurality of alternative routes to display green light signals according to the traffic cycle, based on the diversion instruction.

11. The method of claim 10, wherein the performing anomaly determination on the target region according to the multi-source data, and determining a plurality of hazard hot zones, includes:
performing the anomaly determination on the target region and determining a plurality of potential hazard hot zones and confidence levels corresponding to the plurality of potential hazard hot zones according to the road image data through an anomaly recognition model, wherein the anomaly recognition model is a machine learning model; and
determining the plurality of hazard hot zones according to the terminal report data, the sensor data, the plurality of potential hazard hot zones, and the confidence levels corresponding to the plurality of potential hazard hot zones.

12. The method of claim 11, wherein the performing the anomaly determination on the target region according to the road image data through an anomaly recognition model, includes:
generating a monitoring control instruction through a first vector database according to a plurality of potential obstacle points and trajectory anomaly features corresponding to the plurality of potential obstacle points output by the anomaly recognition model, wherein the monitoring control instruction includes a monitoring angle and a monitoring focal distance; and
controlling a monitoring device to adjust to the monitoring angle and perform image acquisition at the monitoring focal distance, based on the monitoring control instruction.

13. The method of claim 12, wherein the performing the anomaly determination on the target region according to the road image data through an anomaly recognition model, further includes:
generating a first lane change instruction according to the plurality of potential obstacle points, a position of the monitoring device, and the monitoring angle; and
controlling a corresponding vehicle terminal to perform a lane-changing prompt based on the first lane change instruction, to make a vehicle drive away from a line-of-sight obstruction region of the monitoring device.

14. The method of claim 13, wherein the controlling a corresponding vehicle terminal to perform a lane-changing prompt based on the first lane change instruction, to make a vehicle drive away from a line-of-sight obstruction region of the monitoring device, includes:
adjusting a sending time of the first lane change instruction according to an average vehicle gap on a plurality of lanes.

15. The method of claim 10, wherein the determining a plurality of alternative routes according to a determination result of the anomaly determination and a regional road network topology map, includes:
updating the regional road network topology map according to a real-time traffic flow matrix; and
determining the plurality of alternative routes according to an updated regional road network topology map and the determination result of the anomaly determination.

16. The method of claim 15, wherein the determining the plurality of alternative routes according to an updated regional road network topology map and the determination result of the anomaly determination includes:
determining recommended priorities of the plurality of alternative routes according to the updated regional road network topology map; and
sending the plurality of alternative routes to corresponding vehicle terminals according to the recommended priorities.

17. The method of claim 15, wherein the determining the plurality of alternative routes according to an updated regional road network topology map and the determination result of the anomaly determination further includes:
determining a second lane-changing instruction according to the updated regional road network topology map and a plurality of potential obstacle points; and
controlling a corresponding vehicle terminal to perform a lane-changing prompt based on the second lane-changing instruction.

18. The method of claim 17, wherein the plurality of potential obstacle points are determined based on an anomaly recognition model.

19. An apparatus for performing emergency monitoring of traffic anomalies in a smart city based on an Internet of Things (IoT) large-scale model, comprising a processor, wherein the processor is configured to execute the method for performing emergency monitoring of traffic anomalies in a smart city based on the IoT large-scale model of claim 10.
